(19) United States
(12) Patent Application Publication
(10) Pub. No.: US 2006/0150219 A1
(43) Pub. Date: Jul. 6, 2006

(54) Satellite digital multimedia broadcasting receiver of single tuning type

(75) Inventors: Byung Jin Lee, Suwon (KR); Seok Chan Song, Hwasung (KR); Bong Joon Choi, Seoul (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/086,835

(22) Filed: Mar. 22, 2005

(30) Foreign Application Priority Data
Jan. 3, 2005 (KR) 10-2005-262

(51) Int. Cl. H04N 7/20

(52) U.S. Cl. 725/69; 725/68

(57) ABSTRACT

Disclosed herein is a satellite digital multimedia broadcasting (DMB) receiver of a single tuning type which is applicable to a personal mobile terminal or a communication device or broadcasting reception device of a vehicle or etc. The satellite DMB receiver comprises a circular polarization, a linear polarization, a signal selection switch for selecting one of the satellite DMB signal received by the circular polarization antenna and the repeated DMB signal received by the linear polarization antenna, a DMB tuner for removing a carrier frequency component of an output DMB signal from the signal selection switch to output a zero IF signal, a code division multiplex (CDM) demodulation unit for performing a CDM demodulation operation with respect to the zero IF signal from the DMB tuner, and a controller for outputting the switching signal to the signal selection switch.

### RELATED APPLICATIONS

The present application is based on, and claims priority from, Korean Application Number 2005-000262, filed Jan. 3, 2005, the disclosure of which is incorporated by reference herein in its entirety.

### BACKGROUND OF THE INVENTION

1. Field of the Invention

The present invention relates to a satellite digital multimedia broadcasting (DMB) receiver which is applicable to a personal mobile terminal or a communication device or broadcasting reception device of a vehicle or etc., and more particularly to a satellite DMB receiver of a single tuning type which is capable of selecting one of a satellite DMB signal (circularly polarized signal) and a repeated DMB signal (linearly polarized signal) and processing reception of the selected DMB signal through a single satellite DMB tuner, thereby simplifying the satellite DMB tuner configuration, so that the satellite DMB receiver can be made with small size and at low cost and operated at low power.

2. Description of the Related Art

Recently, with the rapid development of mobile communication technologies and the diversity of multimedia broadcasting contents, the convergence of telecommunications and broadcasting has been rapidly advanced. A digital multimedia broadcasting (DMB) system is a new concept service proposed to meet demand for multimedia services and overcome spatial limitations of existing broadcasting systems. This DMB system is roughly provided with a repeated DMB service and a satellite DMB service, the concept of which is illustrated in FIG. 1.

FIG. 1 is a schematic view illustrating the concept of a conventional satellite DMB service.

The concept of the satellite DMB service will hereinafter be described with reference to FIG. 1. A DMB satellite transmits a circularly polarized satellite DMB signal with a center frequency of about 2.6 GHz (and/or 11 GHz). This satellite DMB signal is received by a DMB receiver equipped in a mobile terminal or a DMB receiver installed in a home or vehicle. However, present on the earth may be shadow regions in which it is next impossible to receive the satellite DMB signal transmitted from the DMB satellite, due to its weak strength, such as urban regions where high-rise buildings stand close together.

In order to receive the satellite DMB signal in such a shadow region, a complementary terrestrial repeater may be installed on the roof of a building in the shadow region. This complementary terrestrial repeater is adapted to receive the circularly polarized satellite DMB signal, convert it into a linearly polarized repeated DMB signal of about 2.6 GHz and re-transmit the converted repeated DMB signal so that it can be received by the DMB receiver.

That is, in the satellite DMB service concept, because it is difficult to receive the satellite DMB signal in satellite shadow regions such as urban regions where many buildings are present, service providers install complementary terrestrial repeaters, as mentioned above, in the shadow regions. As a result, the repeated DMB signal is received predominantly over the satellite DMB signal in the urban regions and the satellite DMB signal is received at a quality higher than that of the repeated DMB signal in the outer regions. In other words, it is preferred to process reception of the repeated DMB signal in the urban regions and process reception of the satellite DMB signal in the outer regions.

For this reason, it is necessary to receive the repeated DMB signal transmitted from the complementary terrestrial repeater, as well as the satellite DMB signal transmitted from the DMB satellite. Furthermore, a satellite DMB receiver and a complementary terrestrial repeater DMB receiver must be provided to receive the satellite DMB signal and the repeated DMB signal, respectively. However, in order to reduce the burden of having to purchase both the two receivers, a technique has been proposed to receive both the satellite DMB signal and repeated DMB signal through one satellite DMB receiver.

One example of such conventional satellite DMB receivers capable of receiving both the satellite DMB signal and repeated DMB signal will hereinafter be described with reference to FIGS. 2 to 4.

FIG. 2 is a block diagram showing the configuration of a conventional satellite DMB receiver.

As shown in FIG. 2, the conventional satellite DMB receiver comprises a circular polarization antenna ANT1 for receiving a circularly polarized satellite DMB signal Sin1 transmitted from a DMB satellite, a linear polarization antenna ANT2 for receiving a linearly polarized repeated DMB signal Sin2 transmitted from a complementary terrestrial repeater, a first DMB tuner 10 for removing a carrier frequency component of the satellite DMB signal Sin1 received by the circular polarization antenna ANT1 to output a first zero intermediate frequency (IF) signal ZIF1, a second DMB tuner 20 for removing a carrier frequency component of the repeated DMB signal Sin2 received by the linear polarization antenna ANT2 to output a second zero IF signal ZIF2, and a code division multiplex (CDM) demodulation unit 30 for selecting one of the first zero IF signal ZIF1 from the first DMB tuner 10 and the second zero IF signal ZIF2 from the second DMB tuner 20 and performing a CDM demodulation operation with respect to the selected signal. The conventional satellite DMB receiver further comprises a controller 40 for comparing the strength of an output signal SA from the CDM demodulation unit 30 with that of a reference signal and outputting an enable signal SE and selection signal SS for selection of one of the first zero IF signal ZIF1 and second zero IF signal ZIF2 having a higher strength to the CDM demodulation unit 30 as a result of the comparison, and a forward error correction (FEC) unit 50 for performing an FEC operation with respect to a CDM-demodulated signal DM from the CDM demodulation unit 30 to provide an error-corrected output signal Sout. As a result, the CDM demodulation unit 30 selects and demodulates only one of the first zero IF signal ZIF1 and second zero IF signal ZIF2 having a higher quality.

As stated above, the conventional satellite DMB receiver has the first and second DMB tuners 10 and 20, the configurations of which will hereinafter be described with reference to FIG. 3.

FIG. 3 is a circuit diagram showing the internal configurations of the first and second DMB tuners 10 and 20 in FIG. 2.

As shown in FIG. 3, the first DMB tuner 10 includes a first low-noise amplifier 11 for low-noise amplifying the satellite DMB signal Sin1 received by the circular polarization antenna ANT1, a first band pass filter 12 for passing an output signal from the first low-noise amplifier 11 at a predetermined band, an oscillator 13 for generating a predetermined oscillation signal SOSC, and a first mixer 14 for mixing an output signal from the first band pass filter 12 with the oscillation signal SOSC and outputting the mixed result as the first zero IF signal ZIF1.

As also shown in FIG. 3, the second DMB tuner 20 includes a second low-noise amplifier 21 for low-noise amplifying the repeated DMB signal Sin2 received by the linear polarization antenna ANT2, a second band pass filter 22 for passing an output signal from the second low-noise amplifier 21 at a predetermined band, and a second mixer 23 for mixing an output signal from the second band pass filter 22 with the oscillation signal SOSC from the first DMB tuner 10 and outputting the mixed result as the second zero IF signal ZIF2.

As stated above, the conventional satellite DMB receiver has two tuners, or the first and second DMB tuners 10 and 20, which are substantially the same in configuration. The CDM demodulation unit 30, which selects one of the first and second zero IF signals ZIF1 and ZIF2 outputted from the first and second DMB tuners 10 and 20, is constructed as shown in FIG. 4.

FIG. 4 is a block diagram showing the internal configuration of the CDM demodulation unit 30 in FIG. 2.

As shown in FIG. 4, the CDM demodulation unit 30 includes a first analog/digital (A/D) converter (ADC) 31 for A/D-converting the first zero IF signal ZIF1 from the first DMB tuner 10, a second ADC 32 enabled in response to the enable signal SE for A/D-converting the second zero IF signal ZIF2 from the second DMB tuner 20, a switch 33 for selecting one of an output signal SA1 from the first ADC 31 and an output signal SA2 from the second ADC 32 in response to the selection signal SS, and a CDM demodulator 34 for performing the CDM demodulation operation with respect to an output signal from the switch 33.

As stated previously, the enable signal SE and the selection signal SS are provided from the controller 40, the control operation of which will hereinafter be described with reference to FIG. 5.

FIG. 5 is a flow chart illustrating the control operation of the controller 40 in FIG. 2.

As shown in FIGS. 4 and 5, if power PSA1 of the output signal SA1 from the first ADC 31 in the CDM demodulation unit 30 is lower than reference power Pref (S41), the controller 40 provides the enable signal SE to the second ADC 32 in the CDM demodulation unit 30 to turn it on (S42), and then compares the power PSA1 of the output signal SA1 from the first ADC 31 with power PSA2 of the output signal SA2 from the second ADC 32 (S43).

At this time, if the power PSA1 of the output signal SA1 from the first ADC 31 is lower than the power PSA2 of the output signal SA2 from the second ADC 32, the controller 40 outputs the selection signal SS to the switch 33 to select the output signal SA2 from the second ADC 32 (S44).

On the contrary, if the power PSA1 of the output signal SA1 from the first ADC 31 is not lower than the reference power Pref at step S41, the controller 40 selects the output signal SA1 from the first ADC 31. Also, if the power PSA1 of the output signal SA1 from the first ADC 31 is not lower than the power PSA2 of the output signal SA2 from the second ADC 32 at step S43, the controller 40 turns off the second ADC 32 (S45) and, at the same time, selects the output signal SA1 from the first ADC 31 (S46).

Special regard must be paid to the size and power consumption of the aforementioned conventional satellite DMB receiver to install the DMB receiver in a personal mobile terminal requiring low power. However, there is a limitation in miniaturizing the conventional satellite DMB receiver in that the two DMB tuners are required and the CDM demodulation unit is complicated. As a result, the conventional satellite DMB receiver is high in current consumption and power consumption.

### SUMMARY OF THE INVENTION

Therefore, the present invention has been made in view of the above problems, and it is an object of the present invention to provide a satellite DMB receiver of a single tuning type which is capable of selecting one of a satellite DMB signal (circularly polarized signal) and a repeated DMB signal (linearly polarized signal) and processing reception of the selected DMB signal through a single satellite DMB tuner, thereby simplifying the satellite DMB tuner configuration, so that the satellite DMB receiver can be made with small size and at low cost and operated at low power.

In accordance with the present invention, the above and other objects can be accomplished by the provision of a satellite digital multimedia broadcasting (DMB) receiver of a single tuning type, comprising: a circular polarization antenna for receiving a circularly polarized satellite DMB signal from a DMB satellite; a linear polarization antenna for receiving a linearly polarized repeated DMB signal from a complementary terrestrial repeater; a signal selection switch for selecting one of the satellite DMB signal received by the circular polarization antenna and the repeated DMB signal received by the linear polarization antenna in response to a switching signal; a DMB tuner for removing a carrier frequency component of an output DMB signal from the signal selection switch to output a zero IF signal; a code division multiplex (CDM) demodulation unit for performing a CDM demodulation operation with respect to the zero IF signal from the DMB tuner; and a controller for outputting the switching signal to the signal selection switch if power of an output signal from the CDM demodulation unit is lower than reference power.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the concept of a conventional satellite DMB service;

FIG. 2 is a block diagram showing the configuration of a conventional satellite DMB receiver;

FIG. 3 is a circuit diagram showing the internal configurations of first and second DMB tuners in FIG. 2;

FIG. 4 is a block diagram showing the internal configuration of a CDM demodulation unit in FIG. 2;

FIG. 5 is a flow chart illustrating a control operation of a controller in FIG. 2;

FIG. 6 is a block diagram showing the configuration of a satellite DMB receiver of a single tuning type according to the present invention;

FIG. 7 is a circuit diagram showing the internal configuration of a satellite DMB tuner in FIG. 6;

FIG. 8 is a block diagram showing the internal configuration of a CDM demodulation unit in FIG. 6; and

FIG. 9 is a flow chart illustrating a control operation of a controller in FIG. 6.

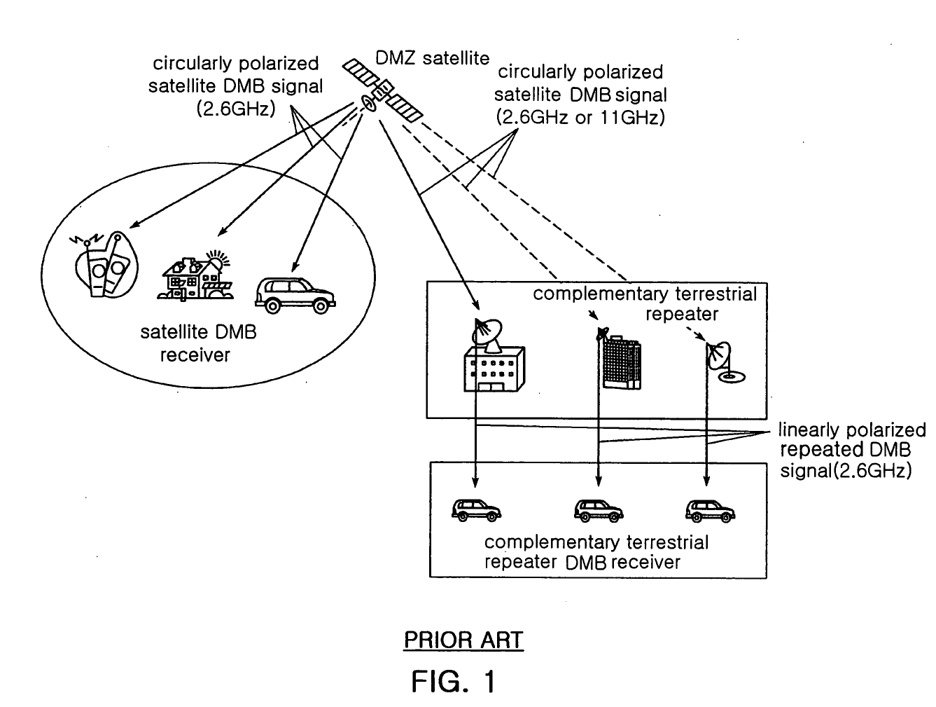

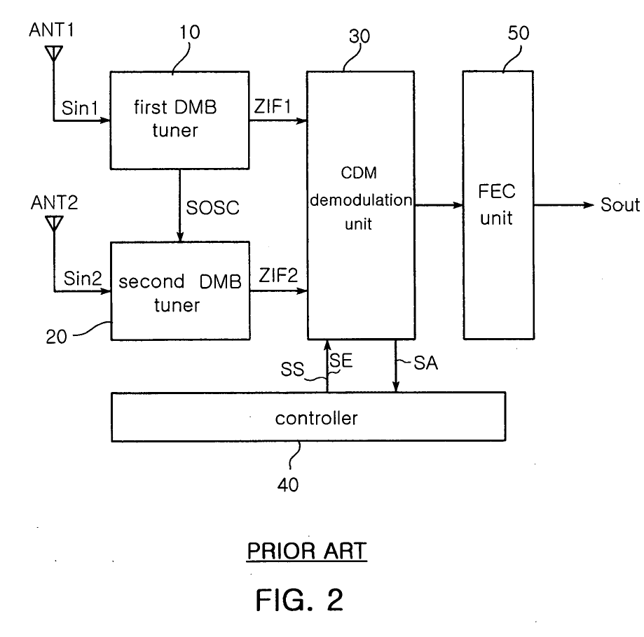

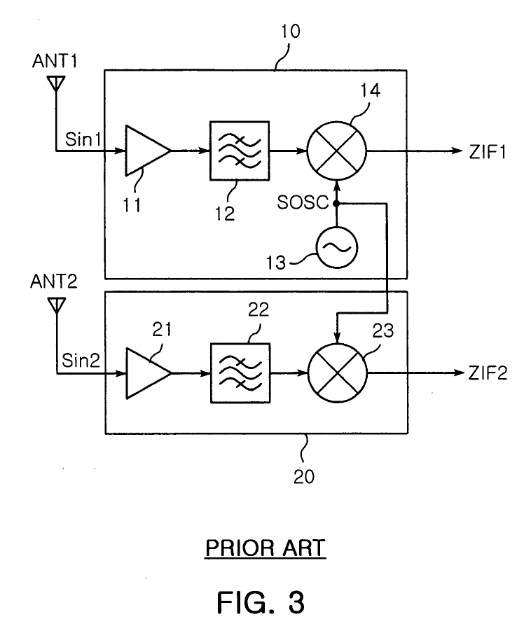

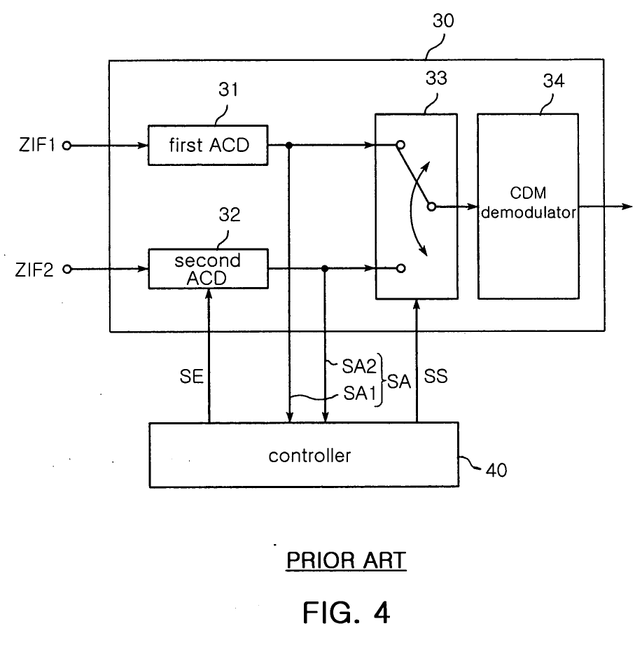

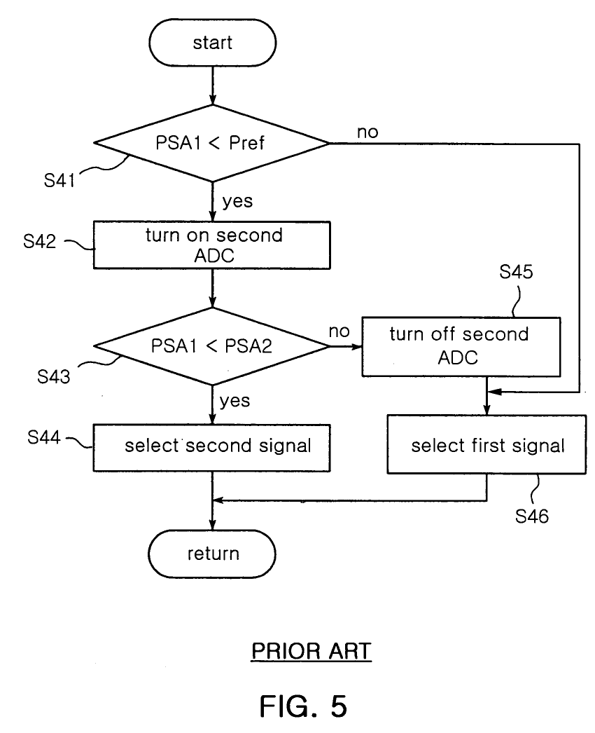

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

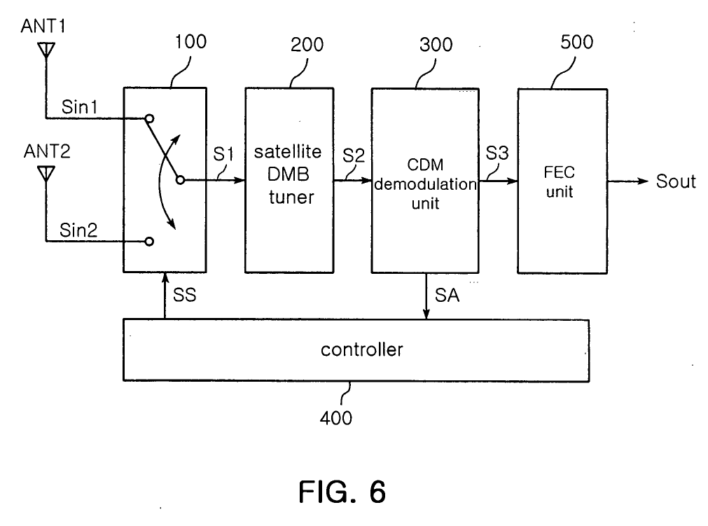

FIG. 6 is a block diagram showing the configuration of a satellite DMB receiver of a single tuning type according to the present invention.

As shown in FIG. 6, the satellite DMB receiver of the single tuning type according to the present invention comprises a circular polarization antenna ANT1 for receiving a circularly polarized satellite DMB signal Sin1 from a DMB satellite, a linear polarization antenna ANT2 for receiving a linearly polarized repeated DMB signal Sin2 from a complementary terrestrial repeater, a signal selection switch 100 for selecting one of the satellite DMB signal Sin1 received by the circular polarization antenna ANT1 and the repeated DMB signal Sin2 received by the linear polarization antenna ANT2 in response to a switching signal SS, a satellite DMB tuner 200 for removing a carrier frequency component of an output DMB signal S1 from the signal selection switch 100 to output a zero IF signal S2, a CDM demodulation unit 300 for performing a CDM demodulation operation with respect to the zero IF signal S2 from the DMB tuner 200, and a controller 400 for outputting the switching signal SS to the signal selection switch 100 if power PSA of an output signal SA from the CDM demodulation unit 300 is lower than reference power Pref.

Preferably, the reference power Pref is set to minimum power to satisfy a reference bit error rate (BER).

The satellite DMB receiver of the present invention further comprises an FEC unit 500 for performing an FEC operation with respect to a CDM-demodulated signal S3 from the CDM demodulation unit 300 to provide an error-corrected output signal Sout.

Preferably, the signal selection switch 100 is adapted to select the satellite DMB signal Sin1 received by the circular polarization antenna ANT1 in a normal state, and select the repeated DMB signal Sin2 received by the linear polarization antenna ANT2 only when the switching signal SS is inputted thereto.

Alternatively, the signal selection switch 100 may select the repeated DMB signal Sin2 received by the linear polarization antenna ANT2 in the normal state, and select the satellite DMB signal Sin1 received by the circular polarization antenna ANT1 only when the switching signal SS is inputted thereto.

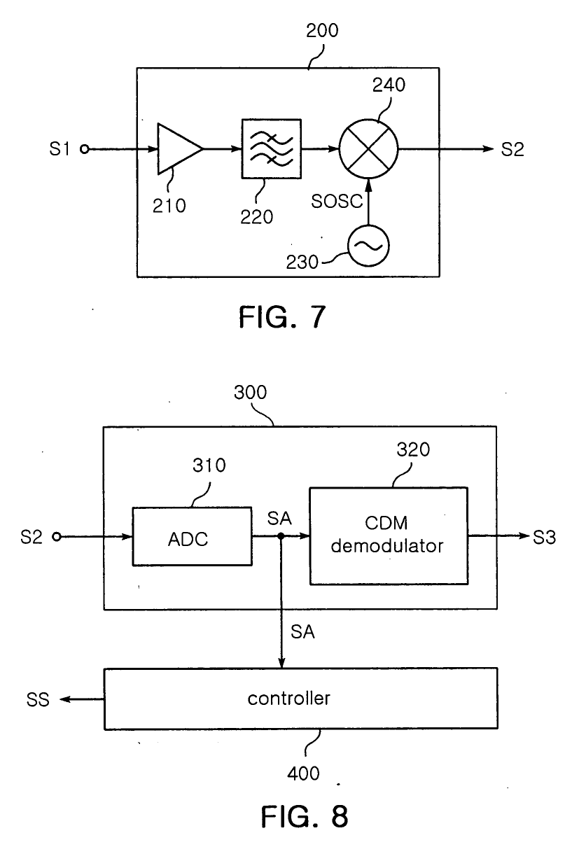

FIG. 7 is a circuit diagram showing the internal configuration of the satellite DMB tuner 200 in FIG. 6.

With reference to FIG. 7, the DMB tuner 200 includes a low-noise amplifier 210 for low-noise amplifying the output DMB signal S1 from the signal selection switch 100, a band pass filter 220 for passing an output signal from the low-noise amplifier 210 at a predetermined band, an oscillator 230 for generating a predetermined oscillation signal SOSC, and a mixer 240 for mixing an output signal from the band pass filter 220 with the oscillation signal SOSC and outputting the mixed result as the zero IF signal S2.

Preferably, an automatic gain control (AGC) amplifier is adopted as the low-noise amplifier 210. Alternatively, the low-noise amplifier 210 may include a fixed amplifier and an AGC amplifier.

FIG. 8 is a block diagram showing the internal configuration of the CDM demodulation unit 300 in FIG. 6.

With reference to FIG. 8, the CDM demodulation unit 300 includes an ADC 310 for A/D-converting the zero IF signal S2 from the DMB tuner 200 to provide the output signal SA, and a CDM demodulator 320 for performing the CDM demodulation operation with respect to the output signal SA from the ADC 310.

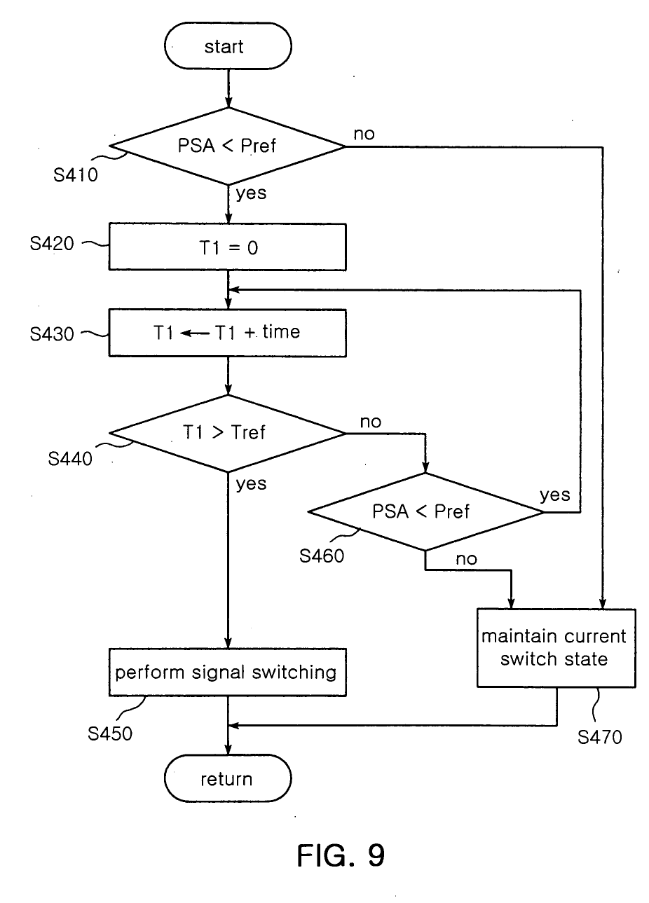

FIG. 9 is a flow chart illustrating a control operation of the controller 400 in FIG. 6.

With reference to FIGS. 8 and 9, the controller 400 is adapted to output the switching signal SS to the signal selection switch 100 when a time T1 during which the power PSA of the signal SA remains lower than the reference power Pref has elapsed over a predetermined reference time Tref.

Preferably, the reference time Tref is set to a time to enable the satellite DMB receiver to more accurately determine whether the state of a currently received signal is poor.

Next, the function and effect of the present invention will be described in detail in conjunction with the annexed drawings.

According to the present invention, an antenna switch is installed in a satellite DMB receiver with a single DMB tuner to select one of a circular polarization antenna or linear polarization antenna according to a given situation. That is, a determination is made as to which one of signals received by the circular and linear polarization antennas is currently predominant in the satellite DMB receiver, and the antenna switch connects only one of the two antennas to an input of the DMB tuner on the basis of the determination so that the DMB tuner can receive a higher-power one of the signals received by the two antennas.

For example, in the satellite DMB service concept, when the satellite DMB receiver moves from a satellite signal reception area to a complementary terrestrial repeater service area or vice versa, a handover is performed in which the predominant one of the satellite DMB signal and repeated DMB signal is changed therebetween. This handover can be known by detecting the strength of a received signal.

A description will hereinafter be given of the operation of the satellite DMB receiver according to the present invention with reference to FIGS. 6 to 9.

With reference to FIG. 6, the satellite DMB receiver of the single tuning type according to the present invention includes the circular polarization antenna ANT1 and the linear polarization antenna ANT2. The circular polarization antenna ANT1 receives a circularly polarized satellite DMB signal Sin1 of about 2.6 GHz from a DMB satellite, and the linear polarization antenna ANT2 receives a linearly polarized repeated DMB signal Sin2 of about 2.6 GHz from a complementary terrestrial repeater.

At this time, the signal selection switch 100 selects one of the satellite DMB signal Sin1 received by the circular polarization antenna ANT1 or the repeated DMB signal Sin2 received by the linear polarization antenna ANT2 in response to the switching signal SS from the controller 400 which will be described later in detail.

For example, in the normal state, the signal selection switch 100 selects the satellite DMB signal Sin1 received by the circular polarization antenna ANT1 and outputs it to the DMB tuner 200. When the switching signal SS is inputted in the normal state, the signal selection switch 100 selects the repeated DMB signal Sin2 received by the linear polarization antenna ANT2 and outputs it to the DMB tuner 200.

Thereafter, the DMB tuner 200 removes a carrier frequency component of an output DMB signal S1 from the signal selection switch 100 to output a zero IF signal S2 to the CDM demodulation unit 300. Preferably, the zero IF signal S2 is a baseband signal obtained by removing a carrier frequency component of about 2.6 GHz from the DMB signal S1.

Subsequently, the CDM demodulation unit 300 performs the CDM demodulation operation with respect to the zero IF signal S2 from the DMB tuner 200 to provide a CDM-demodulated signal S3 to the FEC unit 500. Then, the FEC unit 500 performs the FEC operation with respect to the CDM-demodulated signal S3 from the CDM demodulation unit 300 to provide an error-corrected output signal Sout.

The controller 400 outputs the switching signal SS to the signal selection switch 100 if power PSA of an output signal SA from the CDM demodulation unit 300 is lower than the reference power Pref.

With reference to FIG. 7, in the DMB tuner 200, the low-noise amplifier 210 low-noise amplifies the output DMB signal S1 from the signal selection switch 100 and outputs the amplified signal to the band pass filter 220. The band pass filter 220 passes the output signal from the low-noise amplifier 210 at a predetermined band of, for example, 2.630 to 2.655 GHz. The oscillator 230 generates a predetermined oscillation signal SOSC of 2.6425 GHz and outputs it to the mixer 240. The mixer 240 mixes an output signal from the band pass filter 220 with the oscillation signal SOSC and outputs the mixed result as the zero IF signal S2 to the CDM demodulation unit 300.

With reference to FIG. 8, in the CDM demodulation unit 300, the ADC 310 A/D-converts the zero IF signal S2 of about 25 MHz from the DMB tuner 200 to provide the output signal SA, and the CDM demodulator 320 performs the CDM demodulation operation with respect to the output signal SA from the ADC 310 to output the CDM-demodulated signal S3 of about 5 MHz.

With reference to FIGS. 8 and 9, the controller 400 outputs the switching signal SS to the signal selection switch 100 (S450) when the time T1 during which the power PSA of the signal SA remains lower than the reference power Pref (S410) has elapsed over the predetermined reference time Tref (S420 to S440).

On the other hand, when the power PSA of the signal SA is not lower than the reference power Pref (S410 or S460), the controller 400 maintains the current state of the switch 100 (S470)

In the satellite DMB receiver of the present invention as described above, it is very important to select a proper antenna at a proper time. The receiver must perform an antenna switching operation if the strength of a currently received signal becomes weak while in transit. That is, if the state in which the power of the currently received signal is lower than the reference power satisfying the reference BER continues for the predetermined time T1, the receiver performs the antenna switching operation. Note that sudden variations may occur in signal strength in wireless environments. In order to prevent a handover resulting from such a sudden variation in signal strength, the receiver employs a hysteresis method for performing the switching operation when the power of the currently received signal remains lower than the reference power for the predetermined time.

Accordingly, in the satellite DMB receiver of the present invention, the switch is used for antenna selection, thereby making it possible to simplify the configurations of the DMB tuner and CDM demodulation unit.

As apparent from the above description, the present invention provides a satellite DMB receiver of a single tuning type which is applicable to a personal mobile terminal or a communication device or broadcasting reception device of a vehicle or etc. The satellite DMB receiver is capable of selecting one of a satellite DMB signal (circularly polarized signal) and a repeated DMB signal (linearly polarized signal) and processing reception of the selected DMB signal through a single satellite DMB tuner, thereby simplifying the satellite DMB tuner configuration. Thus, the satellite DMB receiver can be made with small size and at low cost and operated at low power.

Therefore, the size, current consumption and power consumption of the satellite DMB tuner of the present invention can be reduced to about 50% of those of existing tuners. Further, special regard must be paid to the size and power consumption of the satellite DMB receiver to install the DMB receiver in a personal mobile terminal requiring small size and low power. The satellite DMB receiver of the present invention satisfies such factors.

Furthermore, the satellite DMB receiver of the present invention is advantageous in terms of cost in that it is implemented with the tuner of the single type, not the diversity type. On the other hand, deterioration in performance may occur during the antenna switching operation, but can be minimized through a high-rate antenna switching circuit and a data input/output rate adjustment buffer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A satellite digital multimedia broadcasting (DMB) receiver of a single tuning type, comprising:
a circular polarization antenna for receiving a circularly polarized satellite DMB signal from a DMB satellite;
a linear polarization antenna for receiving a linearly polarized repeated DMB signal from a complementary terrestrial repeater;
a signal selection switch for selecting one of the satellite DMB signal received by the circular polarization antenna and the repeated DMB signal received by the linear polarization antenna in response to a switching signal;
a DMB tuner for removing a carrier frequency component of an output DMB signal from the signal selection switch to output a zero IF signal;
a code division multiplex (CDM) demodulation unit for performing a CDM demodulation operation with respect to the zero IF signal from the DMB tuner; and
a controller for outputting the switching signal to the signal selection switch if power of an output signal from the CDM demodulation unit is lower than reference power.

2. The satellite DMB receiver as set forth in claim 1, wherein the signal selection switch is adapted to select the satellite DMB signal received by the circular polarization antenna in a normal state, and select the repeated DMB signal received by the linear polarization antenna only when the switching signal is inputted thereto.

3. The satellite DMB receiver as set forth in claim 1, wherein the DMB tuner includes:
a low-noise amplifier for low-noise amplifying the output DMB signal from the signal selection switch;
a band pass filter for passing an output signal from the low-noise amplifier at a predetermined band;
an oscillator for generating a predetermined oscillation signal; and
a mixer for mixing an output signal from the band pass filter with the oscillation signal and outputting the mixed result as the zero IF signal.

4. The satellite DMB receiver as set forth in claim 1, wherein the CDM demodulation unit includes:
an analog/digital (A/D) converter (ADC) for A/D-converting the zero IF signal from the DMB tuner to provide the output signal from the CDM demodulation unit; and
a CDM demodulator for performing the CDM demodulation operation with respect to the output signal from the ADC.

5. The satellite DMB receiver as set forth in claim 1, wherein the controller is adapted to output the switching signal to the signal selection switch when a time during which the power of the output signal from the CDM demodulation unit remains lower than the reference power has elapsed over a predetermined reference time.
